(19) United States
(12) Patent Application Publication
(10) Pub. No.: US 2024/0194209 A1
(43) Pub. Date: Jun. 13, 2024

(54) APPARATUS AND METHOD FOR REMOVING UNDESIRED AUDITORY ROUGHNESS

(71) Applicant: Fraunhofer-Gesellschaft zur Foerderung der angewandten Forschung e.V., Munich (DE)

(72) Inventors: Sascha DISCH, Erlangen (DE); Steven VAN DE PAR, ILMENAU (DE); Andreas NIEDERMEIER, Erlangen (DE); Bernd EDLER, Erlangen (DE)

(21) Appl. No.: 18/545,607

(22) Filed: Dec. 19, 2023

Related U.S. Application Data
(63) Continuation of application No. PCT/EP2021/075816, filed on Sep. 20, 2021.

(30) Foreign Application Priority Data
Jun. 24, 2021 (EP) 21181590.7

(51) Int. Cl. G10L 19/02; G10L 19/005; G10L 19/26

(52) U.S. Cl. CPC G10L 19/0204; G10L 19/005; G10L 19/26

(57) ABSTRACT

An apparatus for processing an audio input signal to obtain an audio output signal according to an embodiment. The apparatus has a signal analyser configured for determining information on an auditory roughness of one or more spectral bands of the audio input signal. Moreover, the apparatus has a signal processor configured for processing the audio input signal depending on the information on the auditory roughness of the one or more spectral bands.

### CROSS-REFERENCE TO RELATED APPLICATIONS

This application is a continuation of copending International Application No. PCT/EP2021/075816, filed Sep. 20, 2021, which is incorporated herein by reference in its entirety, and additionally claims priority from European Application No. 21181590.7, filed Jun. 24, 2021, which is also incorporated herein by reference in its entirety.

### TECHNICAL FIELD

The present invention relates to an apparatus and a method for removing undesired auditory roughness.

### BACKGROUND OF THE INVENTION

In perceptual audio coding at very low bitrates sometimes modulation artefacts are introduced in audio signals containing clear tonal components. These modulation artefacts are often perceived as auditory roughness. This can be due to quantisation errors or due to audio bandwidth extension which causes an irregular harmonic structure at the edges of replicated bands. Especially, the roughness artefacts due to quantisation errors are difficult to overcome without investing considerably more bits in the encoding of the tonal components.

In low-bit rate audio coding, highly efficient representations of audio signals are used which entail much less digital information as compared to a raw, uncompressed 16-bit sampled PCM audio signal. With modern transform coders like xHE-AAC and MPEG-H, the efficiency is partly obtained by transforming the raw input audio signal to a time-frequency domain representation using an MDCT where each audio frame can be represented with a variable accuracy supervised by a psychoacoustic model and constrained by the available bit-budget. By applying both control mechanisms during the encoding process, the result will be an audio bit-stream where the quantization noise is varying across time-frames and frequency-bands.

In an ideal case, on the encoder side, the quantization noise is shaped such that due to auditory masking it becomes inaudible. For very low bitrates, however, quantization noise will become audible at some point, especially if tonal components are present in the audio signal that have a long duration. The reason is, that quantizing these tonal components may cause varying amplitudes across audio frames, which can cause audible amplitude modulations. With the typical transform-coder audio frame-rate of 43 Hz, these modulations will be added at maximally half of this rate to the signal. This is below the modulation-rate, which causes a roughness percept but within the range that causes (slow) r-Roughness. Furthermore, due to the short-term windowing that is used for transforming time-domain audio-frames to the frequency domain, a perfect, stationary tonal component will be represented within a range of adjacent frequency bins, where some of them are prone to be quantized to zero, especially at very low bit rates.

Reducing bitrates below the range needed for good audio-quality for a pure transform coder is possible with additional semi-parametric techniques like the Spectral Band Replication [1], SBR, used with xHE-AAC, or the Intelligent Gap Filling [2], IGF, used with MPEG-H. High-frequency components are reconstructed using shifted copies of the low-frequency spectrum and spectral envelope shaping. With SBR, or IGF respectively, it is possible to maintain good audio quality.

However, SBR and IGF may amplify roughness artifacts since the tonal frequency components are copied together with the already present temporal modulation.

In addition, those techniques may introduce new roughness artifacts specifically in the transition region between replicated bands: in many audio-frames there could be a deviation from the regular harmonic grid that was present in the original signal. In a recent study it was shown that using a psycho-acoustical model to adaptively decide on the best replication mapping could improve audio quality [5].

Post-filtering approaches for suppressing noise in tonal signal partly remove roughness in a signal. Said approaches rely on the measurement of a fundamental frequency and remove noise through application of a comb-filter tuned to the fundamental frequency or rely on predictive coding, such as the long-term predictor (LTP). All these approaches work for mono-pitches signals only and fail to denoise polyphonic or inharmonic content that exhibit many pitches. In addition, this method cannot distinguish between noise that is present in the original signal or introduced due to the encoding-decoding process.

It would therefore by highly appreciated, if improved concepts for auditory roughness removal would be provided.

The object of the present invention is to provide improved concepts for auditory roughness removal.

### SUMMARY

According to an embodiment, an apparatus for processing an audio input signal to obtain an audio output signal may have: a signal analyser configured for determining information on an auditory roughness of one or more spectral bands of the audio input signal, and a signal processor configured for processing the audio input signal depending on the information on the auditory roughness of the one or more spectral bands.

According to another embodiment, an apparatus for generating an audio output signal from an encoded audio signal may have: an audio decoder configured for decoding the encoded audio signal to obtain a decoded audio signal, and an inventive apparatus for processing an audio input signal as mentioned above, wherein the audio decoder is configured to feed the decoded audio signal as the audio input signal into the inventive apparatus for processing an audio input signal as mentioned above, wherein the inventive apparatus for processing an audio input signal as mentioned above is configured to process the decoded audio signal to obtain the audio output signal.

According to another embodiment, an audio encoder for encoding an initial audio signal to obtain an encoded audio signal and auxiliary information may have: an encoding module for encoding the initial audio signal to obtain the encoded audio signal, and a side information generator for generating and outputting the auxiliary information depending on the initial audio signal and further depending on the encoded audio signal, wherein the auxiliary information has an indication that indicates one or more spectral bands out of a plurality of spectral bands, for which information on an auditory roughness shall be determined on a decoder side.

According to another embodiment, a system may have: an audio encoder for encoding an initial audio signal to obtain an encoded audio signal and auxiliary information, wherein the audio encoder has: an encoding module for encoding the initial audio signal to obtain the encoded audio signal, and a side information generator for generating and outputting the auxiliary information depending on the initial audio signal and further depending on the encoded audio signal, wherein the auxiliary information has an indication that indicates one or more spectral bands out of a plurality of spectral bands, for which information on an auditory roughness shall be determined on a decoder side, and an apparatus for generating an audio output signal from an encoded audio signal as mentioned above, wherein the apparatus for generating an audio output signal from an encoded audio signal is configured to generate the audio output signal depending on encoded audio signal and depending on the auxiliary information.

According to another embodiment, a method for processing an audio input signal to obtain an audio output signal, may have the steps of: determining information on an auditory roughness of one or more spectral bands of the audio input signal, and processing the audio input signal depending on the information on the auditory roughness of the one or more spectral bands.

According to another embodiment, a method for encoding an initial audio signal to obtain an encoded audio signal and auxiliary information, may have the steps of: encoding the initial audio signal to obtain the encoded audio signal, and generating and outputting the auxiliary information depending on the initial audio signal and further depending on the encoded audio signal, wherein the auxiliary information has an indication that indicates one or more spectral bands out of a plurality of spectral bands, for which information on an auditory roughness shall be determined on a decoder side.

Still another embodiment may have a non-transitory computer-readable medium having a computer program for implementing the methods as mentioned above when the method is executed on a computer or signal processor.

An apparatus for processing an audio input signal to obtain an audio output signal according to an embodiment. The apparatus comprises a signal analyser configured for determining information on an auditory roughness of one or more spectral bands of the audio input signal. Moreover, the apparatus comprises a signal processor configured for processing the audio input signal depending on the information on the auditory roughness of the one or more spectral bands.

Moreover, an audio encoder for encoding an initial audio signal to obtain an encoded audio signal and auxiliary information according to an embodiment. The audio encoder comprises an encoding module for encoding the initial audio signal to obtain the encoded audio signal. Moreover, The audio encoder comprises a side information generator for generating and outputting the auxiliary information depending on the initial audio signal and further depending on the encoded audio signal. The auxiliary information comprises an indication that indicates one or more spectral bands out of a plurality of spectral bands, for which information on an auditory roughness shall be determined on a decoder side.

Furthermore, a method for processing an audio input signal to obtain an audio output signal according to an embodiment is provided. The method comprises:
Determining information on an auditory roughness of one or more spectral bands of the audio input signal. And:
Processing the audio input signal depending on the information on the auditory roughness of the one or more spectral bands.

Moreover, a method for encoding an initial audio signal to obtain an encoded audio signal and auxiliary information. The method comprises:
Encoding the initial audio signal to obtain the encoded audio signal. And:
Generating and outputting the auxiliary information depending on the initial audio signal and further depending on the encoded audio signal.

The auxiliary information comprises an indication that indicates one or more spectral bands out of a plurality of spectral bands, for which information on an auditory roughness shall be determined on a decoder side.

Moreover, computer programs are provided, wherein each of the computer programs is configured to implement one of the above-described methods when being executed on a computer or signal processor.

Inter alia, the invention is based on the finding that especially the roughness artifacts due to quantization errors are difficult to mitigate without investing considerably more bits in encoding of tonal components. Embodiments provide new and inventive concepts to remove these roughness artifacts at the decoder side controlled by a small amount of guidance information transmitted by the encoder.

Some of the embodiments are based on the finding that on a frame-by-frame basis, it is very difficult to see amplitude modulations that are occurring across successive frames, the human auditory system would still perceive them as roughness artifacts because it evaluates audio signals across a longer time span than typical frame lengths used in audio coding. In some of the embodiments, a decoded audio signal may, for example, be analyzed with a longer frame-length, so that the amplitude modulation artefacts that are present in tonal components become more visible in the magnitude spectrum as side-bands or even side-peaks that appear next to the primary tonal component.

Considering the appearance of such side-peaks, it would in principle be possible to detect these side-peaks and remove them from the spectrum. Initial experiments have shown that indeed this can be done, and that as a consequence, roughness artefacts are reduced considerably.

Removing such side-peaks blindly may, however, lead to the introduction of audible changes to an audio signal that are not desired. For example, consider an original audio signal that comprises signal parts that are very rough by themselves. In this case the roughness should not be removed. It was indeed found that applying the side-peak removal blindly did lead to clearly audible ‘tubiness’ artefacts in audio signal sections that had a very noise-like or densely filled spectrum.

To overcome the above problem, it appears that the side-peak removal needs to be done selectively, i.e. only in those parts of the audio signal where the encoding and decoding process causes roughness artefacts. Since this decision is related to the perception of such artefacts, such a decision can be driven by a psycho-acoustical model that compares the original and decoded signals to determine in what time-frequency regions, roughness artefacts are introduced.

To remove the above mentioned roughness artifacts a method is provided which uses a psycho-acoustical model, which is sensitive to amplitude modulations. The model is based on the Dau et al. [3] model but includes a number of modifications that have been described already in [4] and will be detailed later. The decisions that the psycho-acoustical model makes about whether roughness artifacts should be removed may, e.g., entail access to the original signal and therefore needs to be done at the encoder side of audio encoding/decoding chain. This implies that auxiliary information needs to be sent from the encoder to the decoder. Although this would increase the bitrate, the increment turns out the be very minor, and could easily be taken from the bit-budget of the transform coder.

Embodiments remove the roughness artefacts at the decoder controlled by small amount of guidance information transmitted from the encoder in the bitstream.

Embodiments provide concepts for the removal of auditory roughness.

Some of the embodiments reduce or remove the roughness artefacts at the decoder side based on the notion that modulation of tonal components creates spectral side peaks next to the primary tone. These side peaks may, e.g., be observed better when the spectral analysis is based on a long time window. In some particular embodiments, the analysis window may, for example, be extended beyond the length of a typical encoding frame.

In principle, the spectral side peaks can be removed from the spectrum, and in this way also the roughness artefact will be removed. The algorithm may, e.g., select the side peaks that need to be removed based on spectral proximity to a stronger primary tonal component. When such a roughness removal is applied blindly to an audio signal, it will also remove roughness that was present in the original audio signal.

In embodiments, a psycho-acoustical model analyses in what spectro-temporal intervals roughness is introduced by the low-bitrate codec. The spectro-temporal intervals from which roughness should be removed are then signaled in an auxiliary part of the bitstream and sent to the decoder.

According to embodiments, a post-processor of a decoder that is fed by a bitstream may, e.g., comprise small guidance information to control the roughness removal.

In another embodiment, the guidance information may, e.g., be estimated at the decoder side.

### BRIEF DESCRIPTION OF THE DRAWINGS

In the following, embodiments of the present invention are described in more detail with reference to the figures, in which:

FIG. 1 illustrates an apparatus for processing an audio input signal to obtain an audio output signal according to an embodiment;

FIG. 2 illustrates an apparatus for generating an audio output signal which comprises an audio decoder and the apparatus for processing of FIG. 1;

FIG. 3 illustrates an audio encoder for encoding an initial audio signal to obtain an encoded audio signal and auxiliary information according to an embodiment;

FIG. 4 illustrates a system according to an embodiment, wherein the system comprises the audio encoder of FIG. 3 and the apparatus of FIG. 2 for generating an audio output signal from an encoded audio signal;

FIG. 5 illustrates an overview of an entire processing chain of roughness reduction according to an embodiment;

FIG. 6 illustrates encoder processing overview of roughness reduction (RR) according to an embodiment;

FIG. 7 illustrates decoder processing overview of roughness reduction according to an embodiment;

FIG. 8 illustrates a detailed diagram of a sparsify process according to an embodiment;

FIG. 9 illustrates an outline of a frame-wise processing the roughness removal decoder algorithm according to an embodiment;

FIG. 10 illustrates an unsmoothed magnitude spectral sample in blue, together with a smoothed magnitude spectrum;

FIG. 11 illustrates a psycho-acoustic model consisting of a basilar membrane filterbank, a haircell model, adaptation loops, and a modulation filterbank;

FIG. 12 illustrates results of a first set of items, consisting of stereo signals, of a listening test using the Web-MUSHRA tool; and

FIG. 13 illustrates results of the second set of items, consisting of mono signals, of a listening test using the Web-MUSHRA tool.

### DETAILED DESCRIPTION OF THE INVENTION

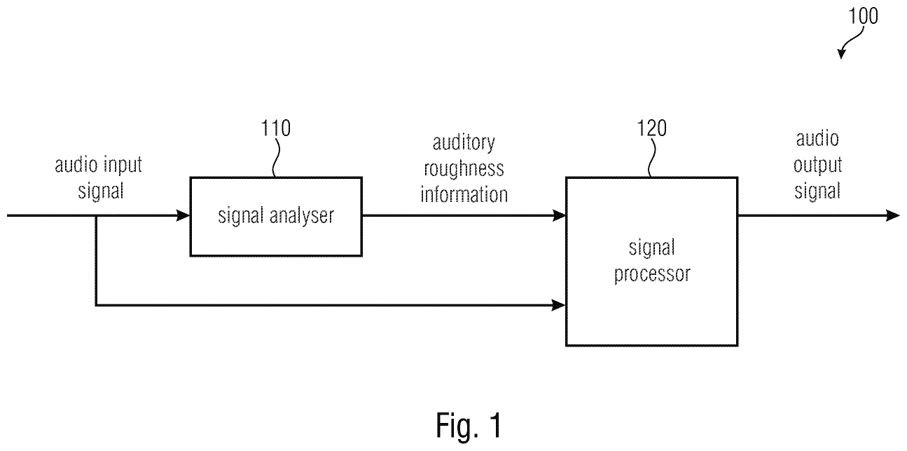

FIG. 1 illustrates an apparatus 100 for processing an audio input signal to obtain an audio output signal according to an embodiment.

The apparatus 100 comprises a signal analyser 110 configured for determining information on an auditory roughness of one or more spectral bands of the audio input signal.

Moreover, the apparatus 100 comprises a signal processor 120 configured for processing the audio input signal depending on the information on the auditory roughness of the one or more spectral bands.

According to an embodiment, the auditory roughness of the one or more spectral bands of the audio input signal may, e.g., depend on a coding error introduced by encoding an original audio signal to obtain the encoded audio signal and/or introduced by decoding the encoded audio signal to obtain the audio input signal.

In an embodiment, the signal analyser 110 configured to determine a plurality of tonal components in the one or more spectral bands. The signal analyser 110 may, e.g., be configured to select one or more tonal components out of the plurality of tonal components depending on a spectral proximity of each of the plurality of tonal components to another one of the plurality of tonal components. Moreover, the signal processor 120 may, e.g., be configured to remove and/or to attenuate and/or to modify the one or more tonal components.

For example, the processor may, e.g., also modify the spectral neighborhood of the removed or attenuated peak, e.g. to preserve band energy after peak manipulation or shift the remaining main peak to preserve the local spectral center of gravity. This entails the application of complex factors to the spectral neighborhood.

According to an embodiment, the signal analyser 110 may, e.g., be configured to receive a bitstream comprising steering information. Moreover, the signal analyser 110 may, e.g., be configured to select the one or more tonal components out of the group of tonal components further depending on the steering information.

In an embodiment, the steering information may, e.g., be represented in a first time-frequency domain or in a first frequency domain, wherein the steering information has a first spectral resolution. The signal analyser 110 may e.g., be configured to determine the plurality of tonal components in a second time-frequency domain having a second spectral resolution, the second spectral resolution being a different spectral resolution than the first spectral resolution. In an embodiment, the second spectral resolution may, e.g., be coarser than the first spectral resolution. In another embodiment, the second spectral resolution may, e.g., be finer that the first spectral resolution.

According to an embodiment, the signal processor 120 may, e.g., be configured to remove and/or to attenuate and/or to modify the one or more tonal components by employing a temporal smoothing or by employing a temporal attenuation.

In an embodiment, the signal processor 120 may, e.g., be configured to process the audio input signal by removing or by attenuating one or more side peaks from a magnitude spectrum of the audio input signal, wherein each side peak of the one or more side peaks may, e.g., be a local peak within the magnitude spectrum being located within a predefined frequency distance from another local peak within the magnitude spectrum, and having a smaller magnitude than said other local peak.

According to an embodiment, the signal analyser 110 may, e.g., be configured to determine a plurality of local peaks in an initial magnitude spectrum of the one or more spectral bands of the audio input signal to obtain the information on the auditory roughness.

In an embodiment, the plurality of local peaks are a first group of a plurality of local peaks. The signal analyser 110 may, e.g., be configured to smooth the initial magnitude spectrum of the one or more spectral bands to obtain a smoothed magnitude spectrum. Moreover, the signal analyser 110 may, e.g., be configured to determine a second group of one or more local peaks in the smoothed magnitude spectrum. Furthermore, the signal analyser 110 may, e.g., be configured to determine, as the information on the auditory roughness, a third group of one or more local peaks which comprises all local peaks of the first group of the plurality of local peaks that do not have a corresponding peak within the second group of local peaks, such that the third group of one or more local peaks does not comprise any local peak of the second group of one or more local peaks.

According to an embodiment, the signal analyser 110 may, e.g., be configured to determine for each peak of the plurality of peaks of the first group, whether the second group comprises a peak being associated with said peak, such that a peak of the second group being located at a same frequency as said peak may, e.g., be associated with said peak, such that a peak of the second group being located within a predefined frequency distance from said peak may, e.g., be associated with said peak, and such that a peak of the second group being located outside the predefined frequency distance from said peak may, e.g., be not associated with said peak.

In an embodiment, the signal processor 120 may, e.g., be configured to process the audio input signal by removing or by attenuating the one or more local peaks of the third group in the initial magnitude spectrum of the one or more spectral bands to obtain a magnitude spectrum of the one or more spectral bands of the audio output signal.

According to an embodiment, for removing or attenuating each peak of the one or more side peaks or of the one or more local peaks of the third group, the signal processor 120 may, e.g., be configured to attenuate said peak and a surrounding area of said peak.

In an embodiment, the signal processor 120 may, e.g., be configured to determine the surrounding area of said peak such that an immediately preceding local minimum of said peak and an immediately succeeding local minimum of said peak limit said surrounding area.

According to an embodiment, the frequency spectrum of the audio input signal comprises a plurality of spectral bands. Moreover, the signal analyser 110 may, e.g., be configured to receive or to determine, the one or more spectral bands out of the plurality of spectral bands, for which the information on the auditory roughness shall be determined. Furthermore, the signal analyser 110 may, e.g., be configured to determine the information on the auditory roughness for said one or more spectral bands of the audio input signal. Moreover, the signal analyser 110 may, e.g., be configured to not determine information on the auditory roughness for any other spectral band of the plurality of spectral bands of the audio input signal.

In an embodiment, the signal analyser 110 may, e.g., be configured to receive the information on the one or more spectral bands, for which the information on the auditory roughness shall be determined, from an encoder side.

According to an embodiment, the signal analyser 110 may, e.g., be configured to receive the information on the one or more spectral bands, for which the information on the auditory roughness shall be determined, as a binary mask or as a compressed binary mask.

In an embodiment, the apparatus 100 may, e.g., be configured receive a selection filter. The signal analyser 110 may, e.g., be configured to determine, the one or more spectral bands out of the plurality of spectral bands, for which the information on the auditory roughness shall be determined, depending on the selection filter.

According to an embodiment, the signal analyser 110 may, e.g., be configured to determine the one or more spectral bands out of the plurality of spectral bands, for which the information on the auditory roughness shall be determined.

In an embodiment, the signal analyser 110 may, e.g., be configured to determine the one or more spectral bands out of the plurality of spectral bands, for which the information on the auditory roughness shall be determined, without that the signal analyser 110 receives side information that indicates said information on the one or more spectral bands for which the information on the auditory roughness shall be determined.

According to an embodiment, the signal analyser 110 may, e.g., be configured to determine the one or more spectral bands out of the plurality of spectral bands, for which the information on the auditory roughness shall be determined, by employing an artificial intelligence concept.

In an embodiment, the signal analyser 110 may, e.g., be configured to determine the one or more spectral bands out of the plurality of spectral bands, for which the information on the auditory roughness shall be determined, by employing a neural network as the artificial intelligence concept being employed by the signal analyser 110. The neural network may, for example, be a convolutional neural network.

According to an embodiment, the signal analyser 110 may, e.g., be configured to not use (e.g., in a filter to remove the roughness peaks) the information on the auditory roughness for those spectral bands of the plurality of spectral bands which comprise one or more transients. For example, in the algorithm, the filter may, e.g., simply not be applied during a frame that comprises a transient.

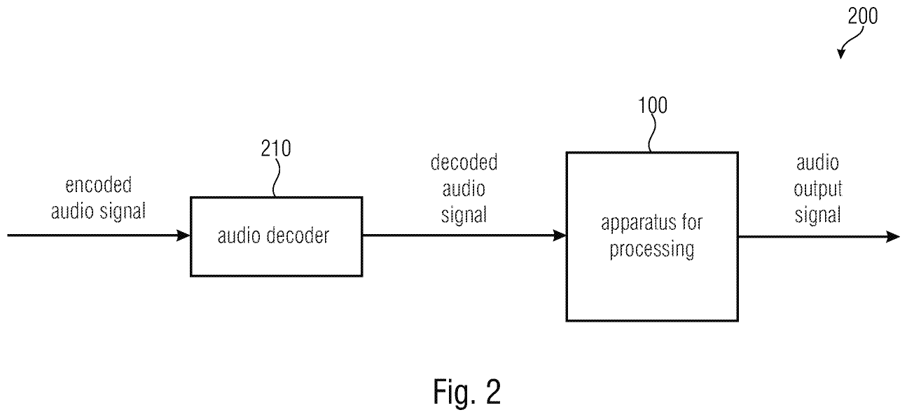

FIG. 2 illustrates an apparatus 200 for generating an audio output signal from an encoded audio signal according to an embodiment.

The apparatus 200 of FIG. 2 comprises an audio decoder 210 configured for decoding the encoded audio signal to obtain a decoded audio signal.

Moreover, the apparatus 200 of FIG. 2 further comprises the apparatus 100 for processing of FIG. 1.

The audio decoder 210 is configured to feed the decoded audio signal as the audio input signal into the apparatus 100 for processing.

The apparatus 100 for processing is configured to process the decoded audio signal to obtain the audio output signal.

According to an embodiment, the audio decoder 210 may, e.g., be configured to decode the encoded audio signal using a first time-block-wise processing with a first frame length.

The signal analyser 110 of the apparatus 100 for processing may, e.g., be configured to determine the information on the auditory roughness using a second time-block-wise processing with a second frame length, wherein the second frame length may, e.g., be longer than the first frame length.

In an embodiment, the audio decoder 210 may, e.g., be configured for decoding the encoded audio signal to obtain the decoded audio signal being a mid-side signal comprising a mid channel and a side channel. The apparatus 100 for processing may, e.g., be configured to process the mid-side signal to obtain the audio output signal of the apparatus 100 for processing. The apparatus 200 for generating may, e.g., further comprise a transform module that transforms the audio output signal so that after the transform the audio output signal comprises a left channel and a right channel of a stereo signal.

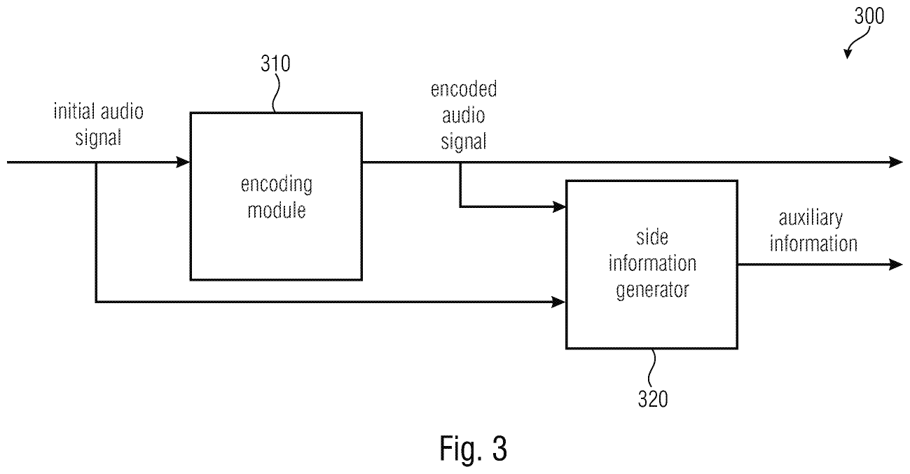

FIG. 3 illustrates an audio encoder 300 for encoding an initial audio signal to obtain an encoded audio signal and auxiliary information according to an embodiment.

The audio encoder 300 comprises an encoding module 310 for encoding the initial audio signal to obtain the encoded audio signal.

Moreover, the audio encoder 300 comprises a side information generator 320 for generating and outputting the auxiliary information depending on the initial audio signal and further depending on the encoded audio signal.

The auxiliary information comprises an indication that indicates one or more spectral bands out of a plurality of spectral bands, for which information on an auditory roughness shall be determined on a decoder side.

According to an embodiment, the side information generator 320 may, e.g., be configured to generate the additional information depending on a perceptual analysis model or a psycho-acoustical model.

In an embodiment, the side information generator 320 may, e.g., be configured to estimate perceived changes in an auditory roughness in the encoded audio signal using the perceptual analysis model or the psycho-acoustical model.

According to an embodiment, the side information generator 320 may, e.g., be configured to generate as the auxiliary information a binary mask that indicates the one or more spectral bands out of the plurality of spectral bands which exhibit an increased roughness, and for which the information on the auditory roughness shall be determined on the decoder side.

In an embodiment, the side information generator 320 may, e.g., be configured to generate the binary mask as a compressed binary mask.

According to an embodiment, the side information generator 320 may, e.g., be configured to generate the auxiliary information by employing a temporal modulation-processing.

In an embodiment, the side information generator 320 may, e.g., be configured to generate the auxiliary information by generating a selection filter.

According to an embodiment, the side information generator 320 may, e.g., be configured to generate the selection filter by employing temporal smoothing.

In an embodiment, the side information generator 320 may, e.g., be configured to generate the indication of the auxiliary information that indicates the one or more spectral bands out of the plurality of spectral bands, for which information on an auditory roughness shall be determined on a decoder side by employing a neural network. The neural network may, for example, be a convolutional neural network.

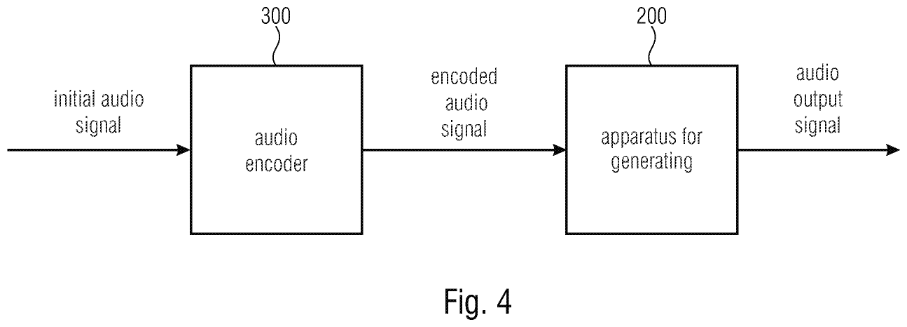

FIG. 4 illustrates a system according to an embodiment.

The system comprises the audio encoder 300 of FIG. 3 for encoding an initial audio signal to obtain an encoded audio signal and auxiliary information.

Moreover, the system comprises the apparatus 200 of FIG. 2 for generating an audio output signal from an encoded audio signal.

The apparatus 200 for generating the audio output signal is configured to generate the audio output signal depending on the encoded audio signal and depending on the auxiliary information.

In the following, some embodiments of the present invention are described.

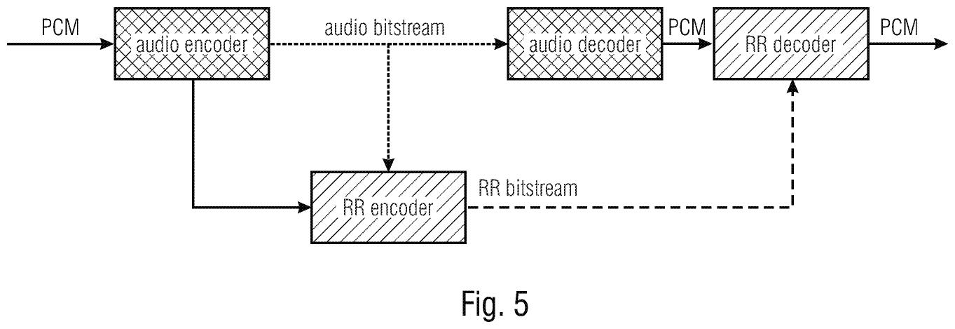

FIG. 5 illustrates an overview of an entire processing chain of roughness reduction (RR) according to an embodiment. Green colored block denote the inventive roughness reduction, blue colored blocks relate to processing blocks usually present in audio codecs.

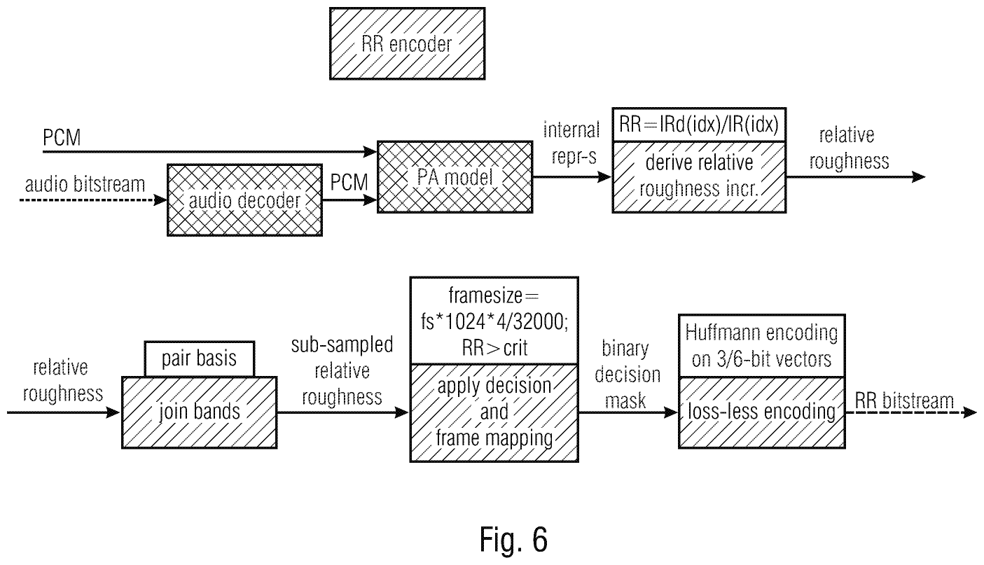

FIG. 6 illustrates encoder processing overview of roughness reduction (RR) according to an embodiment. In the encoder, the roughness reduction encoder part compares the original PCM signal and the encoded and coded signal using a perceptual analysis (PA) model. In order to let this method work, the use of an advanced modulation-based psycho-acoustical model is a good option. The PA model estimates perceived changes in the auditory roughness of the signal and derives a binary mask that indicates spectral bands that exhibit increased roughness. This binary mask is compressed and added to the bitstream of the perceptual coder as side information. Experiments have shown that this auxiliary information entails an additional bitrate of only about 0.4 kbps for mono and stereo signals. The signal flow is sketched in FIG. 6.

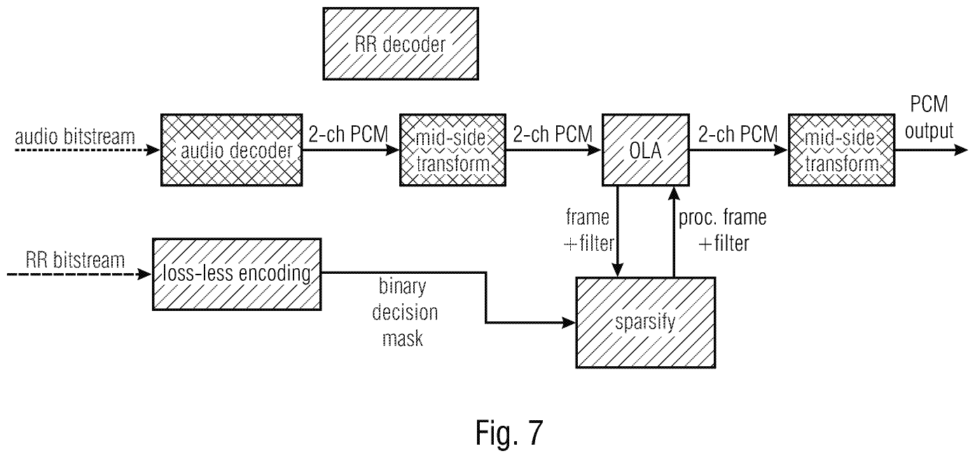

FIG. 7 illustrates decoder processing overview of roughness reduction (RR) according to an embodiment. At the decoder, the roughness reduction decoder part extracts the side information from the bitstream and feeds it to a processing block denoted as “Sparsify”. This block removes unwanted tonal side-peaks in the bands indicated by the binary mask as having an increased roughness. The signal flow is shown in FIG. 7. For stereo signals, the sparsifying takes place in a M/S representation to avoid perceived spatial fluctuations.

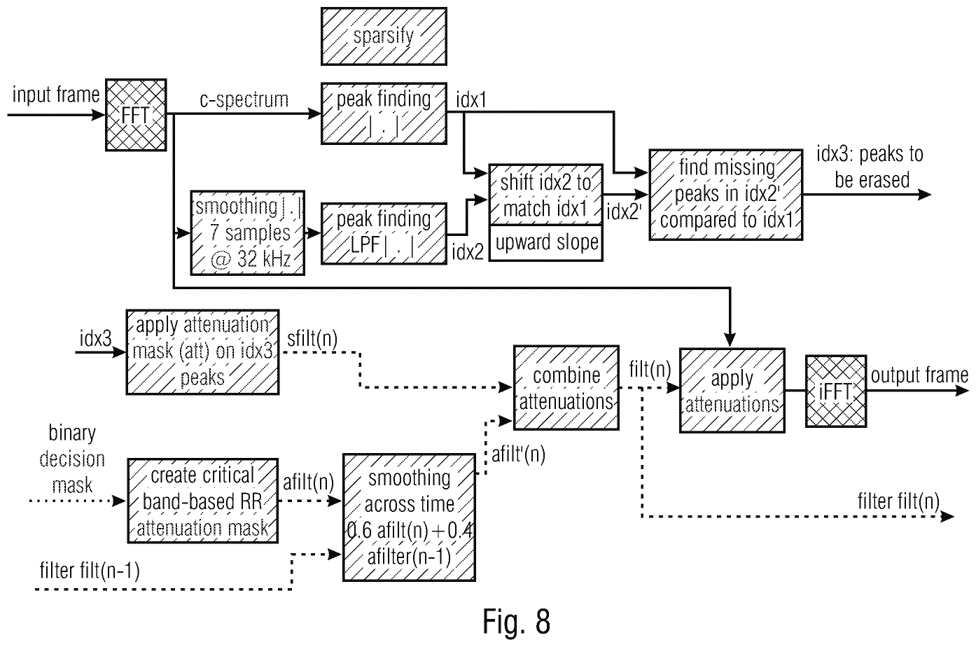

FIG. 8 illustrates a detailed diagram of a “sparsify” process according to an embodiment.

In the following, embodiments of the present invention are described in more detail.

At first, guided auditory roughness removal concepts for audio codecs according to embodiments are described.

In particular, the Roughness-Removal (RR) algorithm will be explained. In some of the embodiments, it may, e.g., entail the extraction of auxiliary information at the encoder side to steer the Roughness Removal that will be performed after the audio signal has been decoded.

Returning to FIG. 5, a schema is shown how a standard audio encoder and decoder is connected to the RR Encoder which sends auxiliary information within the RR bitstream to the RR Decoder. In particular, FIG. 5 illustrates an outlines of an application context of the Roughness Removal Codec. It is built around a conventional audio Encoder-Decoder pair (given in blue).

In order to explain the methods used, at first, the core of the algorithm is described, where spectral components are altered to remove roughness (at the RR Decoder side), and then progress towards how the psychoacoustic model selects parts of the signal where roughness artefacts are introduced (RR Encoder side).

In the following, roughness removal is described in more detail.

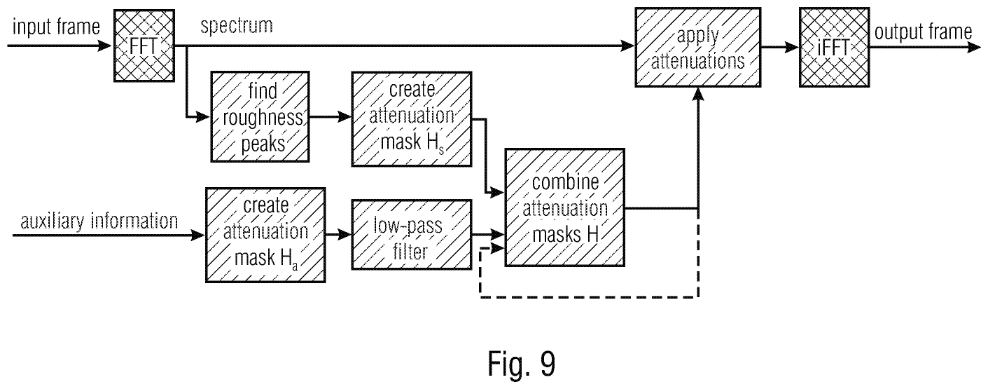

FIG. 9 illustrates an outline of a frame-wise processing the Roughness Removal Decoder algorithm according to an embodiment. A time-domain frame and Auxiliary information are used as input. A time-domain output frame is generated from which spectral components are removed that cause roughness artefacts.

The Roughness Removal Decoder operates on a frame-by-frame basis.

The processing within each frame is outlined in FIG. 9. As can be seen, the time-frame is converted to a spectral representation. In principle, the only operation that is done on this spectrum is to apply an attenuation filter (H) to the spectrum and then convert back to a time domain frame. The filter, H, should be designed such that spectral peaks that cause roughness artefacts are attenuated.

For the derivation of the attenuation filter, two separated filters are derived first, which are seen in the lower two branches of FIG. 9. First, based on the signal spectrum, an algorithm determines all peaks that are associated with roughness. Based on these specific peaks, an attenuation mask Hₛ is derived which has a high spectral resolution. This attenuation mask would simply remove all peaks that cause roughness, including the ones that were present in the original encoded signal. For that reason, the auxiliary information that is obtained at the Roughness Removal Encoder is picked up to determine the spectral bands in which perceptible roughness artefacts have been introduced by the audio encoding algorithm. For these spectral bands, a second attenuation mask is derived (Hₐ) that has low gain for the bands with perceptible roughness artefacts. Since the perceptual model only provides yes-no decisions, it was found to be beneficial to apply a low-pass filter on the output of Hₐ. Both attenuation filters are then combined into a single attenuation filter H. The output of that filter is used as the preceding state for the low-pass filter applied to Hₐ in the next frame. That implies that also the attenuations Hₛ of the previous frame will continue to have an effect in the present frame.

Since r-roughness and roughness are associated with amplitude modulations, audio components that sound rough, should be represented by a main spectral peak, with a nearby side peak that can be separated by as little as 10 Hz. To be able to observe such side peaks, a sufficiently long analysis window needs to be used. In the algorithm that is presented in this paper an analysis window of 5644 samples at 44.1 KHz was used, or an adapted sample length depending on sampling frequency.

In the following, the stage that finds roughness peaks is described with reference to FIG. 9. Many methods could be considered to remove the side peaks that are representing the r-roughness artefacts that are introduced. Here, a method is provided that considers the manner in which roughness artefacts are introduced. First, within the spectrum obtained from the 5644 sample intervals, all local peaks are selected and denoted by \vec{p}ₒ. In FIG. 3, the spectrum is shown in blue, the peaks are marked with blue circles. (Note that many minor peaks appear that have a low amplitude.) Secondly, the magnitude spectrum is smoothed with a 10 sample long Hann window (shown in red); red circles indicate peaks that were found. In this smoothed spectrum, it is thought that the side-peaks introduced due to the encoding process will be largely removed as can be seen in the left-most peak at sample number 620, where a pronounced side peak in the unsmoothed spectrum (blue) is not present anymore in the smoothed spectrum (red). In this smoothed spectrum, all local peaks are again selected and denoted by \vec{p}ₛ.

In principle, the removed side peaks can now be determined by inspecting \vec{p}ₒ; and determining what elements are not found in \vec{p}ₛ. It needs to be noted, however, that a strong peak that appeared in the original spectrum (and is an element in \hat{p}ₛ), may not be at exactly the same spectral location in the smoothed spectrum (with peaks represented in \vec{p}ₛ). When the surrounding spectrum is tilted, after smoothing it can create a bias on the position of the dominant peak. For that reason, first a mapping is derived that indicates what components in \vec{p}ₒ are still present in \vec{p}ₛ, albeit shifted in spectral position. The remaining peaks are then classified as side peaks that need to be removed and are denoted as \vec{p}ᵣ.

For the removal of the side peaks, indicated in \vec{p}ᵣ, first the surrounding spectral range is selected for each peak to be removed. This range is delimited by the first local minimum found at either side of the peak in the unsmoothed spectrum. Within this range, an attenuation of 20 dB is then inserted in the frequency-domain filter, Hₛ, that initially has unity gain. This procedure is repeated for each peak to be removed. As noted, this filter Hₛ cannot be directly applied to the spectrum because it would also remove peaks that were already present in the original signal and which caused roughness.

For that reason a second filter Hₐ is determined based on the auxiliary information from the encoder side which should be used as a selection filter that determines what regions in the side-peak removal filter Hₛ should indeed be applied to the filtering. This selection is obtained via the following equation that creates a new filter:

H=1−(1−Hₛ)(1−Hₐ) (1)

The effect of this combination is that both Hₛ and Hₐ should have provided attenuation in order to result in an attenuation in the new filter H. Although this new attenuation filter H could be applied now to the spectrum in order to remove roughness causing side peaks that are introduced by the encoding process, it was found that this can lead to some perceptible instabilities in the sound excerpts. This may be due to uncertainties in the decision process at the encoder side about which bands comprise roughness artefacts. In addition, the decision at the encoder side is an all-or-nothing decision which is motivated by keeping the bit-rate for sending the auxiliary information very limited. To reduce the instabilities, some temporal smoothing is applied to the filter Hₐ. To do so, the filter H that was obtained in the previous frame is combined with the newly calculated filter Hₐ with coefficients of 0.4 and 0.6, respectively.

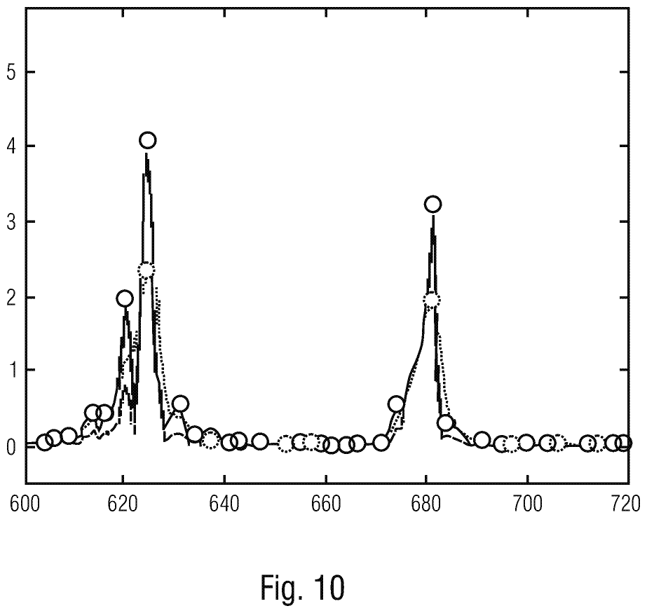

FIG. 10 illustrates an unsmoothed magnitude spectral sample in blue, together with a smoothed magnitude spectrum in red. Correspondingly colored circles represent local peaks in the spectra.

In FIG. 10, the attenuation filter is applied to the original spectrum (in blue), resulting in the green curve which is only visible in the spectral regions where a sizable attenuation was created. It can now be seen that around sample 620, where the original spectral (blue) had a peak, but the smoothed spectrum (red) had no peak, the peak in the blue spectrum is considerable attenuated, in this manner reducing potential audible modulation artefacts.

In the following, a psychoacoustic model for steering the roughness removal is described.

As mentioned in the previous section, the roughness evoking side peaks should only be removed when they result from the audio encoding process. This information may, e.g., entail access to the original signal and can therefore only be obtained at the encoder side. In this section it will be described how a psycho-acoustic model that can detect roughness in audio signals is used for this purpose.

The psycho-acoustic model that is used for this purpose was previously used for steering encoding decisions in a parametric audio encoder [5] and was later shown to be very suitable for making predictions about perceived degradations due to a variety of audio encoding methods [4]. The model is an extension of the Dau et al. model [3] which assumes that for each auditory filter channel, a modulation filterbank provides an analysis of the audio signal in terms of temporal modulation.

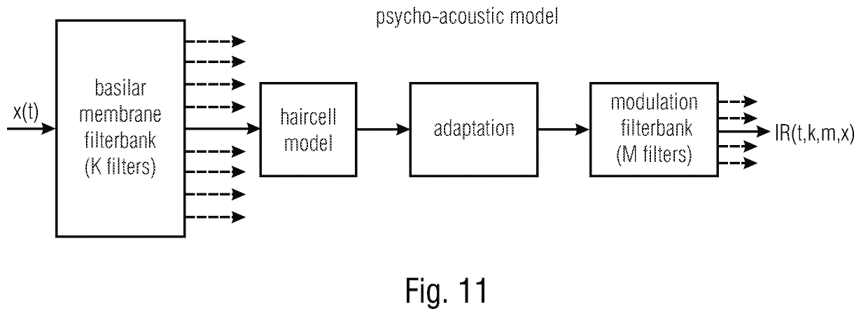

The model is shown schematically in FIG. 11. In particular, FIG. 11 illustrates a psycho-acoustic model consisting of a basilar membrane filterbank, a haircell model, adaptation loops, and a modulation filterbank following Dau et al. [3].

First the audio signal is processed by a number of parallel gamma-tone filters that have band-pass characteristics that approximate the frequency selective processing in the human cochlea and is in line with the original model of Dau et al. [3] and the previous publications [4], [5] except that the gamma-tone filterbank provides a complex valued output from which the magnitude is taken, thus effectively extracting the Hilbert Envelope of the gamma-tone output. This modification was included because of the interaction with the next stage of the model, the adaptation loops, to be explained when discussing the adaptation loops.

The adaptation loops where included in the Dau model to model adaptation processes in the auditory pathway (e.g. the auditory nerve). Each adaptation loop is modelled as an attenuation stage where the attenuation factor is a low-pass filtered version of the output of that loop. As a consequence, adaptation loops, after signal onset, will have a reduced gain which will persist even after off-set of the input signal. This property is used to model forward masking effects observed in listening tests. A total of five adaptation loops were proposed in the Dau model, with different time constants. In steady state, i.e. long after onset, the adaptation loops can be shown to approximate the shape of a logarithmic transformation.

At signal onset, the adaptation loops will not yet have a reduced gain as found towards the steady state situation, which causes a significant overshoot which would cause disproportionate sensitivity to any changes made to the signal onset which is not in line with psycho-acoustic observations. For this reason, the maximum gain of adaptation loops was made dependent on the input level according to a logarithmic rule.

For very low-frequency signals (<100 Hz), the time constants of the adaptation loops will allow to reduce the attenuation inbetween two periods to some extent. This effectively causes the average attenuation to be less and thus increase the overall sensitivity to any changes in input signal at low frequencies. For this reason, the Hilbert envelope is extracted prior to the adaptation loops. This Hilbert Envelope replaces the hair-cell processing used in the original Dau model that consisted of a half-wave rectification followed by a low-pass filter.

After the adaptation loops in each auditory channel, the output is fed into a modulation filterbank, it is comparable to the filterbank proposed in Dau et al., and has an additional stage that removes the DC component from the filter (cf. [4]). This is important because the DC component of a Hilbert envelope can be much higher than the modulated components. Due to the shallow filter shapes of the modulation filters, the modulation filter output can be dominated by the DC component (cf. [5]). Although this property is not so much important in the original model of Dau et al., because that model was only dealing with just noticeable differences in stimuli, in the current setting, it is interesting to know whether strong base-line modulations are already present in the original audio signal. When this is the case, listening tests showed that any added modulation will be less detectable. The presence of strong DC components at the output of the modulation filters would make it difficult to obtain the base-line modulation.

Finally, the outputs of the modulation filterbanks result in an internal representation that is a function of time, t, auditory filter number, k, modulation filter number, m, and which depends on the input signal x. The internal representation is processed to decide whether noticeable additional modulations in the modulation-frequency range associated with roughness are introduced. For this purpose the ratio is calculated between the increase in modulation strength in the modulation filters centered from 5 to 35 Hz and the base-line modulation strength in the same filters for the original audio signal.

In this manner, the relative increase in modulation strength is determined. When this exceeds a criterion value of 0.6, the corresponding time and frequency interval will be signaled to the encoder as an interval where side-peaks need to be removed. In the standard setting of the algorithm, also values are averaged across two neighboring bands to reduce the bit-rate for the side information. In the listening test, however, a condition is added where this averaging across neighboring is omitted to investigate the impact on quality.

In the following, roughness removal encoder and/or decoder properties are described.

As shown in FIG. 5, the roughness removal algorithm is built around an normal encoder-decoder combination; i.e. the algorithm can be applied independently of the codec, but may also be integrated with the codec. At the encoder side, first the audio signal is encoded, resulting in a bitstream that is sent to the decoder side.

The Roughness-Removal Encoder takes up the original input signal and the bitstream in order to directly decode the audio signal again. Using the psychoacoustic model outlined in the previous section, decisions are made about what time-frequency intervals at the decoder side can be subjected to the roughness removal algorithm outlined in Sect. 2.1. The decisions are made based on a mono downmix of the input signal in case the input signal is stereo, which further limits the relative increase in bit-rate needed for this method.

The auxiliary information (RR Bitstream) is sent to the Roughness-Removal Decoder which uses the decoded signal, available at the decoder side to remove roughness causing side peaks from the appropriate signal parts.

It was found that removal of side peaks in frames that comprise transients can lead to considerable pre-echoes.

This is caused by the narrow-band spectral modification that is made with the side-peak removal. To avoid the introduction of pre-echoes, at the decoder side, a transient detector signals frames for which no side-peak removal should be conducted. Note that the filter calculation for the side-peak removal will still continue during such a transient frame, it will only not be applied to the signal.

For a stereo signal, in principle, the roughness removal algorithm could be applied to both channels independently.

It was considered that possibly it could be beneficial to first convert the stereo signal in a mid-side representation and to apply the algorithm twice, and independently on both the mid- and the side-channel.

In the listening test, both options are evaluated. In the encoding process, it is beneficial that the frame rate is fairly slow, frames are separated by 2822 samples at 44.1 kHz sampling frequency (15.6 Hz). In addition, in the standard setting, auxiliary information is provided for the 21 pairs of the 42 bands all together.

The auxiliary information, consisting of single bits for each decision, are grouped in 6 auditory bands and stored as one number with a Huffmann encoder to exploit possible correlations between bands that are near to one another in frequency. An average bitrate of 0.30 kbits/sec is obtained for the items that are used in the listening test when decisions are transmitted per pair of bands, and 0.65 bits/sec when information for single bands is transmitted.

Informal listening experiments have been conducted. The listening test evaluates the quality gain that can be obtained by employing the above-described concepts of embodiments. In particular, the listening tests show that a clear improvement in audio quality is obtained for items encoded at about 14 kbps stereo with a waveform and a parametric coder. In addition, also for items encoded with a pure waveform coder at 32 kbps mono show an improvement when the proposed algorithm is applied. In both cases, the quality improvement is due to removal of roughness artefacts.

To investigate whether the proposed method indeed provides a gain in audio quality, a MUSHRA listing test was conducted. Two different sets of items were used in the listening, the first set were items that were encoded in stereo, the second set in mono. Most of the stereo items were encoded with an experimental waveform encoder that encoded the left and right ear signals independently, each at a bit rate of 32 kbit/sec.

In addition, one item was encoded with an IGF based method. The second set of items were all encoded with an IGF based method. In Table 1 a summary is given of these items.

TABLE 1
Items used in listening test.

| Set | Name | Encoder | Bitrate | Channels |
|---|---|---|---|---|
| 1 | Anchor Song | IGF | xx kbps | 2 |
| 1 | es01 | Waveform | 64 kbps | 2 |
| 1 | es02 | Waveform | 64 kbps | 2 |
| 1 | Rock You | Waveform | 64 kbps | 2 |
| 1 | si01 | Waveform | 64 kbps | 2 |
| 1 | si02 | Waveform | 64 kbps | 2 |
| 1 | squam17 | Waveform | 64 kbps | 2 |
| 2 | braxto | IGF | yy kbps | 1 |
| 2 | brahms | IGF | yy kbps | 1 |
| 2 | fiedel | IGF | yy kbps | 1 |
| 2 | hanco | IGF | yy kbps | 1 |
| 2 | phi7 | IGF | yy kbps | 1 |
| 2 | rosenberg | IGF | yy kbps | 1 |
| 2 | steely | IGF | yy kbps | 1 |

Within the algorithm, there is the option to include mid-side coding (default), but also to independently encode the left and right ear signal. For that reason, in the first set of items, both options were included in the MUSHRA test. Also, the auxiliary information can be transmitted per pair of auditory bands (default) or for each auditory band independently. These two options were included in the second set of items. All measured conditions are listed in Table 2.

TABLE 2
Conditions used in listening test.

| Condition | Set 1 | Set 2 |
|---|---|---|
| Hidden Reference | x | x |
| Anchor (3.5 kHz low-pass) | x | x |
| Unprocessed Decoded | x | x |
| RR, Mid-Side processing (2 Bands) | x | |
| RR, Left-Right processing (2 Bands) | x | |
| RR, 2 Bands (mono) | | x |
| RR, 1 Band (mono) | | x |

The Hidden Reference is the original audio signal, the Anchor a 3.5 kHz low-pass filtered version of the original signal, the Unprocessed Decoded signal represents the signal without roughness removal, RR signifies the various conditions in which the roughness removal algorithms was applied, either with Mid-Side processing, or independent Left-Right processing, or using 2 bands for each bit of auxiliary information or single bands.

In total N . . . subjects participated in the listening test. Listening tests were performed using the Web-MUSHRA tool in home-office using high quality headphones.

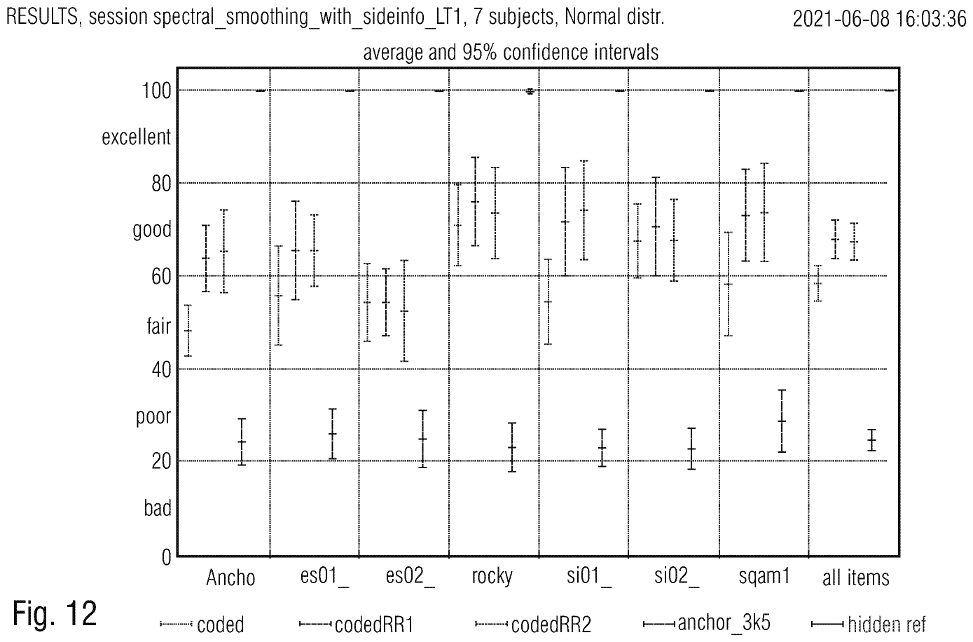

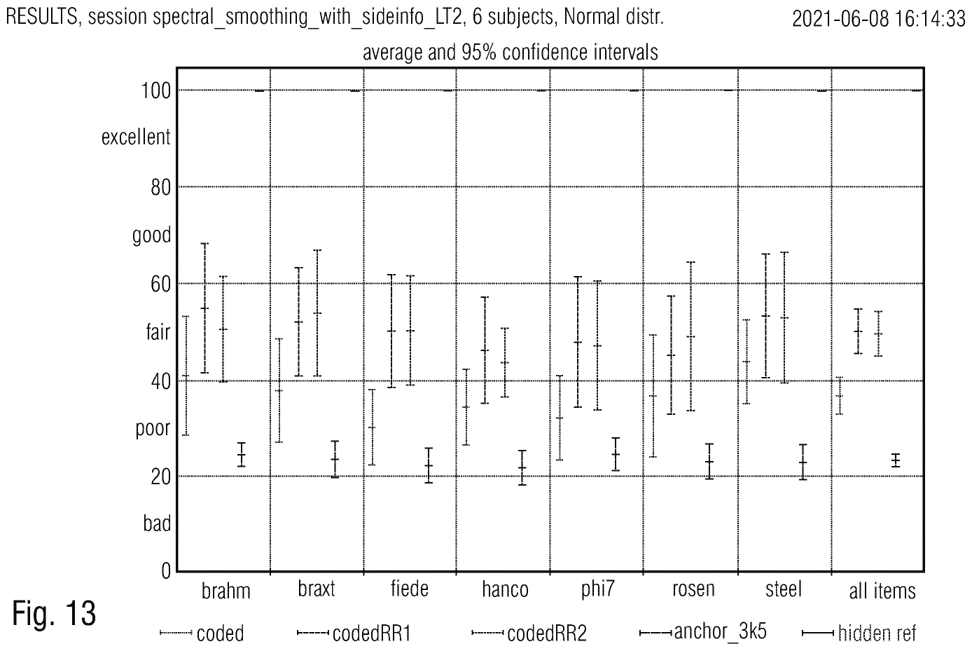

Results are shown in FIG. 12 and FIG. 13.

In particular, FIG. 12 illustrates results of the first set of items, consisting of stereo signals, of a listening test using the Web-MUSHRA tool.

FIG. 13 illustrates results of the second set of items, consisting of mono signals, of a listening test using the Web-MUSHRA tool.

In the following, further embodiments are described.

According to an embodiment, a (e.g., postprocessing) apparatus/method is provided that identifies and removes or attenuates tonal components in the (decoded) audio signal, for example, based on spectral proximity to neighboring components.

In an embodiment, a (e.g., postprocessing) apparatus/method is provided that removes or attenuates tonal components in the decoded signal that is (partly) steered by information sent in the bit stream

According to an embodiment, a (e.g., postprocessing) apparatus/method is provided that uses coarse t/f resolution information from the bitstream and a finer spectral resolution information derived at decoder side.

In an embodiment, for example, time-block-wise processing using longer frame lengths than used in an audio decoder may, e.g., be employed.

According to an embodiment, for example, temporal smoothing or temporal attenuation may, e.g., be employed.

In an embodiment, for example, a transient steered switching window or skipping blocks with transients in the post-processing may, e.g., be employed.

According to an embodiment, for example, stereo signals using mid-side synchronization or coding may, e.g., be employed.

In an embodiment, for example, a temporal modulation-processing may, e.g., be employed based auditory model at encoder side to determine the information in the bitstream.

According to an embodiment, for example, an additional selection filter that is driven by the bitstream selecting regions for which tonal components are removed or attenuated may, e.g., be employed.

In an embodiment, for example, a selection filter that has smooth transitions in the spectral domain may, e.g., be employed.

According to an embodiment, for example, the filter may, e.g., also be subject to temporal smoothing.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] Dietz, M., Liljeryd, L., Kjorling, K., and Kunz, O., “Spectral Band Replication, a Novel Approach in Audio Coding,” in Audio Engineering Society Convention 112, 2002.
[2] Disch, S., Niedermeier, A., Helmrich, C. R., Neukam, C., Schmidt, K., Geiger, R., Lecomte, J., Ghido, F., Nagel, F., and Edler, B., “Intelligent Gap Filling in Perceptual Transform Coding of Audio,” in Audio Engineering Society Convention 141, 2016.
[3] Dau, T., Kollmeier, B., and Kohlrausch, A., “Modelling auditory processing of amplitude modulation. I. Detection and masking with narrow-band carriers,” J. Acoust. Soc. Am., 102, pp. 2892-2905, 1997.
[4] van de Par, S., Disch, S., Niedermeier, A., Burdiel Perez, E., and Edler, B., “Temporal Envelope-Based Psychoacoustic Modelling for Evaluating Non-Waveform Preserving Audio Codecs,” in Audio Engineering Society Convention 147, 2019.
[5] Disch, S., van de Par, S., Niedermeier, A., Burdiel Pérez, E., Berasategui Ceberio, A., and Edler, B., “Improved Psychoacoustic Model for Efficient Perceptual Audio Codecs,” in Audio Engineering Society Convention 145, 2018.

1. An apparatus for processing an audio input signal to acquire an audio output signal, wherein the apparatus comprises:
a signal analyser configured for determining information on an auditory roughness of one or more spectral bands of the audio input signal, and
a signal processor configured for processing the audio input signal depending on the information on the auditory roughness of the one or more spectral bands.

2. The apparatus according to claim 1,
wherein the auditory roughness of the one or more spectral bands of the audio input signal depends on a coding error introduced by encoding an original audio signal to acquire the encoded audio signal and/or introduced by decoding the encoded audio signal to acquire the audio input signal.

3. The apparatus according to claim 1,
wherein the signal analyser configured to determine a plurality of tonal components in the one or more spectral bands, and
wherein the signal analyser is configured to select one or more tonal components out of the plurality of tonal components depending on a spectral proximity of each of the plurality of tonal components to another one of the plurality of tonal components, and
wherein the signal processor is configured to remove and/or to attenuate and/or to modify the one or more tonal components.

4. The apparatus according to claim 3,
wherein the signal analyser is configured to receive a bitstream comprising steering information, and
wherein the signal analyser is configured to select the one or more tonal components out of the group of tonal components further depending on the steering information.

5. The apparatus according to claim 4,
wherein the steering information is represented in a first time-frequency domain or in a first frequency domain, wherein the steering information comprises a first spectral resolution,
wherein the signal analyser is configured to determine the plurality of tonal components in a second time-frequency domain comprising a second spectral resolution, the second spectral resolution being a different spectral resolution than the first spectral resolution.

6. The apparatus according to claim 3,
wherein the signal processor is configured to remove and/or to attenuate and/or to modify the one or more tonal components by employing a temporal smoothing or by employing a temporal attenuation.

7. The apparatus according to claim 1,
wherein the signal processor is configured to process the audio input signal by removing or by attenuating one or more side peaks from a magnitude spectrum of the audio input signal, wherein each side peak of the one or more side peaks is a local peak within the magnitude spectrum being located within a predefined frequency distance from another local peak within the magnitude spectrum, and comprising a smaller magnitude than said other local peak.

8. The apparatus according to claim 1,
wherein the signal analyser is configured to determine a plurality of local peaks in an initial magnitude spectrum of the one or more spectral bands of the audio input signal to acquire the information on the auditory roughness.

9. The apparatus according to claim 8,
wherein the plurality of local peaks are a first group of a plurality of local peaks,
wherein the signal analyser is configured to smooth the initial magnitude spectrum of the one or more spectral bands to acquire a smoothed magnitude spectrum,
wherein the signal analyser is configured to determine a second group of one or more local peaks in the smoothed magnitude spectrum,
wherein the signal analyser is configured to determine, as the information on the auditory roughness, a third group of one or more local peaks which comprises all local peaks of the first group of the plurality of local peaks that do not comprise a corresponding peak within the second group of local peaks, such that the third group of one or more local peaks does not comprise any local peak of the second group of one or more local peaks.

10. The apparatus according to claim 9,
wherein the signal processor is configured to process the audio input signal by removing or by attenuating the one or more local peaks of the third group in the initial magnitude spectrum of the one or more spectral bands to acquire a magnitude spectrum of the one or more spectral bands of the audio output signal.

11. (canceled)

12. (canceled)

13. (canceled)

14. The apparatus according to claim 1,
wherein the frequency spectrum of the audio input signal comprises a plurality of spectral bands,
wherein the signal analyser is configured to receive or to determine the one or more spectral bands out of the plurality of spectral bands, for which the information on the auditory roughness shall be determined,
wherein the signal analyser is configured to determine the information on the auditory roughness for said one or more spectral bands of the audio input signal, and
wherein the signal analyser is configured to not determine information on the auditory roughness for any other spectral band of the plurality of spectral bands of the audio input signal.

15. The apparatus according to claim 14,
wherein the signal analyser is configured to receive the information on the one or more spectral bands, for which the information on the auditory roughness shall be determined, from an encoder side; or
wherein the signal analyser is configured to receive the information on the one or more spectral bands, for which the information on the auditory roughness shall be determined, as a binary mask or as a compressed binary mask; or
wherein the apparatus is configured receive a selection filter,
wherein the signal analyser is configured to determine, the one or more spectral bands out of the plurality of spectral bands, for which the information on the auditory roughness shall be determined, depending on the selection filter; or
wherein the signal analyser is configured to determine the one or more spectral bands out of the plurality of spectral bands, for which the information on the auditory roughness shall be determined or
wherein the signal analyser is configured to not use the information on the auditory roughness for those spectral bands of the plurality of spectral bands which comprise one or more transients.

16. (canceled)

17. (canceled)

18. (canceled)

19. (canceled)

20. (canceled)

21. (canceled)

22. (canceled)

23. (canceled)

24. An apparatus for generating an audio output signal from an encoded audio signal, wherein the apparatus comprises:
an audio decoder configured for decoding the encoded audio signal to acquire a decoded audio signal, and
an apparatus for processing according to claim 1,
wherein the audio decoder is configured to feed the decoded audio signal as the audio input signal into the apparatus for processing according to claim 1,
wherein the apparatus for processing according to claim 1 is configured to process the decoded audio signal to acquire the audio output signal.

25. (canceled)

26. (canceled)

27. An audio encoder for encoding an initial audio signal to acquire an encoded audio signal and auxiliary information, wherein the audio encoder comprises comprising:
an encoding module for encoding the initial audio signal to acquire the encoded audio signal, and
a side information generator for generating and outputting the auxiliary information depending on the initial audio signal and further depending on the encoded audio signal,
wherein the auxiliary information comprises an indication that indicates one or more spectral bands out of a plurality of spectral bands, for which information on an auditory roughness shall be determined on a decoder side.

28. The audio encoder according to claim 27,
wherein the side information generator is configured to generate the additional information depending on a perceptual analysis model or a psycho-acoustical model; or
wherein the side information generator is configured to generate as the auxiliary information a binary mask that indicates the one or more spectral bands out of the plurality of spectral bands which exhibit an increased roughness, and for which the information on the auditory roughness shall be determined on the decoder side; or
wherein the side information generator is configured to generate the auxiliary information by employing a temporal modulation-processing; or
wherein the side information generator is configured to generate the auxiliary information by generating a selection filter; or
wherein the side information generator is configured to generate the indication of the auxiliary information that indicates the one or more spectral bands out of the plurality of spectral bands, for which information on an auditory roughness shall be determined on a decoder side by employing a neural network.

29. (canceled)

30. (canceled)

31. (canceled)

32. (canceled)

33. (canceled)

34. (canceled)

35. (canceled)

36. (canceled)

37. A system comprising,
an audio encoder for encoding an initial audio signal to acquire an encoded audio signal and auxiliary information, wherein the audio encoder comprises:
an encoding module for encoding the initial audio signal to acquire the encoded audio signal, and
a side information generator for generating and outputting the auxiliary information depending on the initial audio signal and further depending on the encoded audio signal,
wherein the auxiliary information comprises an indication that indicates one or more spectral bands out of a plurality of spectral bands, for which information on an auditory roughness shall be determined on a decoder side, and
an apparatus according to claim 24 for generating an audio output signal from an encoded audio signal,
wherein the apparatus according to claim 24 is configured to generate the audio output signal depending on encoded audio signal and depending on the auxiliary information.

38. A method for processing an audio input signal to acquire an audio output signal, wherein the method comprises:
determining information on an auditory roughness of one or more spectral bands of the audio input signal, and
processing the audio input signal depending on the information on the auditory roughness of the one or more spectral bands.

39. A method for encoding an initial audio signal to acquire an encoded audio signal and auxiliary information, wherein the method comprises:
encoding the initial audio signal to acquire the encoded audio signal, and
generating and outputting the auxiliary information depending on the initial audio signal and further depending on the encoded audio signal,
wherein the auxiliary information comprises an indication that indicates one or more spectral bands out of a plurality of spectral bands, for which information on an auditory roughness shall be determined on a decoder side.

40. A non-transitory computer-readable medium comprising a computer program for implementing the method of claim 38 when the method is executed on a computer or signal processor.

41. A non-transitory computer-readable medium comprising a computer program for implementing the method of claim 39 when the method is executed on a computer or signal processor.
